(19) United States
(12) Patent Application Publication
(10) Pub. No.: US 2003/0181079 A1
(43) Pub. Date: Sep. 25, 2003

(54) ELECTRICAL CONNECTOR

(76) Inventors: Iosif R. Korsunsky, Harrisburg, PA (US); Robert W. Brown, Harrisburg, PA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/104,832

(22) Filed: Mar. 22, 2002

(51) Int. Cl. H01R 12/00

(52) U.S. Cl. 439/79

(57) ABSTRACT

An electrical connector (1) straddle-mounted on an edge (20) of a printed circuit board (2) includes an insulative housing (10) having an elongated groove (11) for mating. A plurality of receiving channels (13) each used to receive a support subassembly (3) is formed adjacently to and communicated with the mating groove (11). The support subassembly (3) includes a base (30) with signal terminals (5) and a grounding member (4) attached thereon. Every terminal (5) includes an engaging end (51) exposed to the mating groove (11) and a tail end (52) extending out of the receiving channel (13) in a suspended status. And the grounding member (4) includes a plurality of contacting legs (42) extending from the grounding member (4) and being suspended similar to the tail end (52) of every terminal (5). A flexible portion (34) with a thinned area is disposed on the base (30) to define a separating portion (33) from the base (30). The flexible portion (34) is a hinge area used to facilitate relocating the separating portion (33) relative to the base (30). The separating portion (33) of the base (30) can be always positioned between the tail ends (52) of terminals (5) and the contacting legs (42) of the grounding member (4) to electrically insulate them from each other though the shape of tail ends (52) and contacting legs (42) are changed to be mounted on another desired printed circuit board with a different thickness. And the separating portion can be moved for the assembling of every terminal (5) and the grounding member (4) when they need to put together to form the support subassembly (3) being inserted into the housing (10).

### BACKGROUND OF THE INVENTION

1. Field of the Invention

The present invention is related to an electrical connector, especially to a straddle connector which is straddle-mounted on an edge of a printed circuit board and the terminals of this connector are connected to the pads disposed at either one or both sides of the printed circuit board.

2. Description of the Related Art

Printed circuit boards play an important role in the computer industry. Till today, most of expected electrical or electronic functions are achieved on a motherboard, one kind of printed circuit boards which is installed inside of every computer. Many electronic components, such as CPU, memory etc., and peripheral devices like CD ROM, hard disk etc. must be connected to the motherboard before they work. However, these necessary connections are huge which complicates the layout of the motherboard and reduces the available space on the motherboard. Therefore, considering the corresponding location and size of some electronic components and the motherboard, some of the supporting connectors are straddle-mounted on the edge of a motherboard or a daughter board connected thereto to save space of the motherboard and facilitate the installation of some larger peripheral devices. Two known contact arrangements for connectors to be straddle mounted on a printed circuit board can be considered for adoption. Chen et al. U.S. Pat. No. 5,292,265 and Long U.S. Pat. No. 5,893,764 both introduce connectors having two rows of contacts where contacts of one row are engaged on one side of the printed circuit board while contacts of the other row are engaged on the opposite side. A curved tail of every contact is disposed for engaging with the corresponding pad mounted on the printed circuit board due to the difference between the thickness of the printed circuit board and the distance of two contact rows. These vulnerable contact tails cause problems without auxiliary guiding means or fixtures before the connector is straddle mounted on the printed circuit board. Tor et al. U.S. Pat. Nos. 5,823,799 and 5,971,775 show all the contacts are soldered onto only one side of the printed circuit board, no matter how many rows of contacts the connector has. This type of contact tail arrangement is more easily made and protected because it avoids unnecessary collision in the mounting process. But the space on the edge side of printed circuit board is still limited which results in the corresponding soldering pads on the printed circuit board being so close to each other that the soldering process is complicated. The above-mentioned two arrangements may be adopted at the same time when the number of contacts is increasing, but the size of the connector is shortened, following the current design tendency. Therefore, high density connectors with multi rows of contacts have been introduced to meet the need of high speed transmission. Schmidgall et al. European Patent Application No. 01 126552 shows a connector with three rows of contacts is straddle mounted on a printed circuit board by soldering two rows of contacts on the same side of the printed circuit board. The row of contacts that is farther from the edge surface of the printed circuit board than others needs longer and specially bent tails to be engaged with the printed circuit board. Dense soldering pads cause higher cost and more difficult soldering, and well designed guiding and fixing means may be needed to protect contact tails from colliding damage.

Furthermore, crosstalk is usually a concern in high density connectors, especially for high speed transmission. Grounding means is then added to surround and shield contacts from each other in order to get higher electrical performance. Cohen et al. U.S. Pat. No. 6,152,742 and Grabbe et al. U.S. Pat. Nos. 5,320,541 and 5,813,871 all introduce a straddle mount connector having a grounding plate disposed between two rows of contacts. The grounding plate has tails extending near tails of contacts and being soldered onto the same edge of the printed circuit board to establish electrically grounding paths. Obviously, there are many more tails, including signal and grounding ones, than needed to connect with the printed circuit board. Cost is high and it takes time to arrange these connector tails and soldering pads on the printed circuit board when space of the printed circuit board is limited. And specialized parts like uncommon holes on the printed circuit board shown in above patents are always expensive and time consuming. Especially, tails of the grounding plate and tails of contacts cannot be spaced far enough away from each other due to the limited space. Shorting the circuit of the printed circuit board may result, because tails of the grounding plate may accidentally collide with the contact tails due to the strong straddle mount force of the connector to the printed circuit board and the high density arrangement of the connector tails. To avoid the accidental collision due to the use of many long tails, the expensive method of insert molding may be necessary to assemble contacts and the grounding plate with the connector housing.

### SUMMARY OF THE INVENTION

Therefore, an object of the present invention is to provide a straddle mount connector having an adjustable insulated separating portion to isolate terminal tail ends and legs of the grounding member from each other to reduce the potential of accidental collision while they are installed onto the printed circuit board.

Another object of the present invention is to provide a straddle mount connector having an adjustable insulated separating portion to isolate terminal tail ends from legs of the grounding member properly at all times, even though the connector may be installed onto respectively at least two printed circuit boards each having a different board thickness from the other.

Another object of the present invention is to provide a straddle mount connector having an adjustable insulated separating portion to assemble terminals and the grounding member mechanically rather than using the expensive process of insert molding when tail ends of terminals and legs of the grounding member vary to be mounted on at least two different printed circuit boards.

To obtain the above objects, an electrical connector straddle-mounted on an edge of a printed circuit board includes an insulative housing having an elongated groove for mating. A plurality of receiving channels each used to receive a support subassembly is formed adjacently to and communicated with the mating groove. The support subassembly includes a plane-like base having a plurality of parallel arranged passageways formed on one surface of the base and a protrusion formed on the other. Pin-like signal terminals are inserted into the passageways respectively along the surface of the base and a plate-like grounding member is installed abutting against the other surface of the support subassembly to be fixed on the protrusion. A bar portion transversely protruding from the surface of the base having passageways, several holding portions formed in a hook shape on one edge side of the grounding member and the protrusion are all used to stop the insertion of the support subassembly when it is assembled into the housing. Every terminal includes an engaging end exposed to the mating groove once the terminal is inserted into the housing accompanying the support subassembly, and a tail end extending out of the receiving channel in a suspended status. And the grounding member includes a plurality of contacting legs extending away from the grounding member for a predetermined distance and being suspended similar to the tail end of every terminal.

Specifically, a flexible portion with a thinned area on the base defines a separating portion from the base. The flexible portion is a hinge area used to facilitate relocating the separating portion relative to the base. Therefore, the separating portion of the base can always be positioned between the tail ends of terminals and the contacting legs of the grounding member to electrically insulate them from each other though the shape of tail ends and contacting legs are changed to be mounted on another desired printed circuit board with a different thickness. And the separating portion can be moved for the ease of assembling every terminal and grounding member when they are put together to form the support subassembly being inserted into the housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a mating side plane view of an electrical connector in accordance with the present invention;

FIG. 2 is a lengthwise side plane view of the electrical connector in accordance with the present invention;

FIG. 3 is a sectional view of the electrical connector along the 3-3 line in FIG. 1 and showing the electrical connector straddle mounted on a printed circuit board;

FIG. 4 is a sectional view of the electrical connector along the 4-4 line in FIG. 1 and showing the electrical connector straddle mounted on a printed circuit board;

FIG. 5 is a sectional view of the electrical connector showing its anchoring member used to fix the electrical connector onto the printed circuit board in accordance with the present invention along the 5-5 line in FIG. 1;

FIG. 6 is a longitudinal side view of the support subassembly of the electrical connector in accordance with the present invention showing the assembled grounding member;

FIG. 7 is a longitudinal side view of the support subassembly of the electrical connector showing the other side of the support subassembly where the terminals are assembled;

FIG. 8 is a schematic sectional view of the support subassembly of the electrical connector in accordance with the present invention showing the assembling method of the terminals and the grounding member;

FIG. 9 is a schematic sectional view of the electrical connector in accordance with the present invention showing the assembling method of the support subassembly;

FIG. 10 is a sectional view of the electrical connector in accordance with the present invention showing the electrical connector straddle mounted on a printed circuit board which is thicker than the printed circuit board shown in FIG. 3;

FIG. 11 is a schematic sectional view of the support subassembly of the electrical connector used to be straddle mounted on the thicker printed circuit board shown in FIG. 10 and showing the assembling method of the terminals and the grounding member;

FIG. 12 is a schematic sectional view of the electrical connector used to be straddle mounted on the thicker printed circuit board shown in FIG. 10 and showing the assembling method of the support subassembly;

### DESCRIPTION OF THE PREFERRED EMBODIMENT

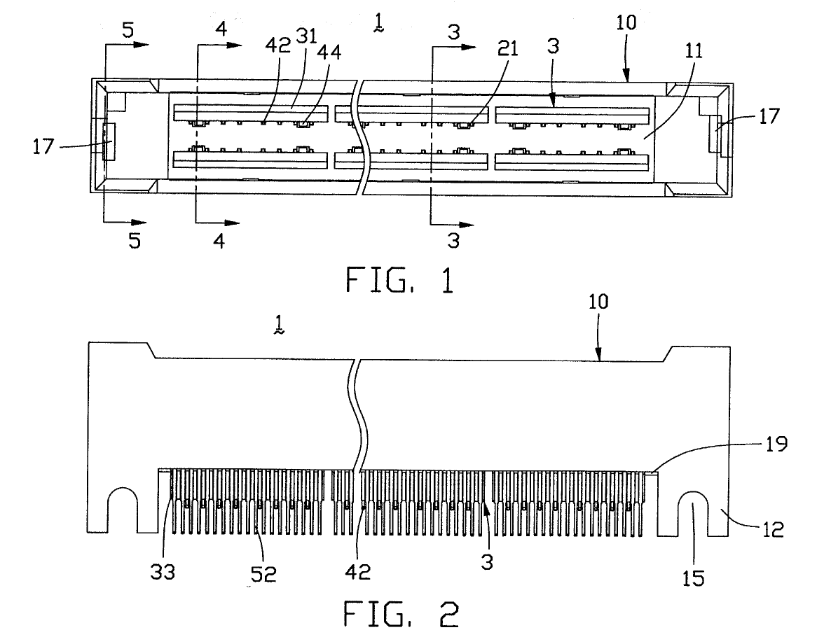

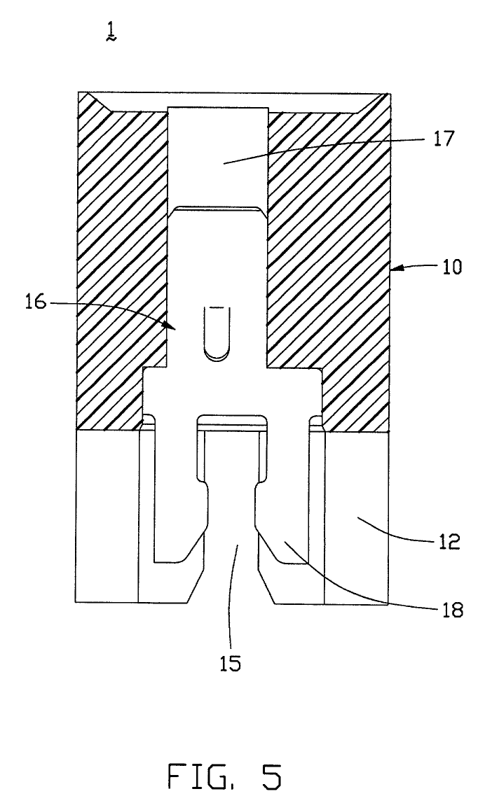

Referring to FIGS. 1 to 3 and 5, the present invention is related to an electrical connector 1 which is straddle-mounted on an edge 20 of a printed circuit board 2. The connector 1 includes an insulative housing 10 having a mating elongated groove 11 extending along one side face of the housing 10. Even number of receiving channels 13 formed adjacently to and communicated with the mating groove 11 each has an opening formed on another side face opposing to the side face having the groove 11 and extending along the lengthwise direction of the opposing side face in one of two predetermined parallel rows. One inner sidewall 14 of every receiving channel 13 is sloped from it corresponding opening on the opposite side face of the housing 10 to the neighborhood of the mating groove 11. On the central portion of the housing 10 formed between every two adjacent receiving channels 13 of these two channel rows, several recesses 21 are formed on edges abutting both of the groove 11 and any one of the receiving channel 13 to be communicated with them at the same time. And several apertures 22 are formed on the opposite side face of the central portion of the housing 10 away from the groove 11 and arranged in the central lengthwise line of the side face. A mounting portion 12 perpendicularly extending from the opposing side face at both distal ends of the housing 10 for a predetermined distance has a slot 15 formed parallel to the groove 11 for receiving the edge 20 of the printed circuit board 2. A standoff 19 protruding on the opposite side face and next to each mounting portion 12 is used to stop the excess insertion of the edge 20 of the printed circuit board 2 into the slot 15. Meanwhile, an anchoring member 16 receiving in a slit 17 formed in every one of two distal ends of the housing 10 has a fork-shaped tail 18 extending outside of the slit 17 and exposing its portions in the corresponding slot 15. The fork-shaped tail 18 of the anchoring member 16 can then yieldably engage with the edge 20 of the printed circuit board 2 when the edge 20 is inserted into the slot 15.

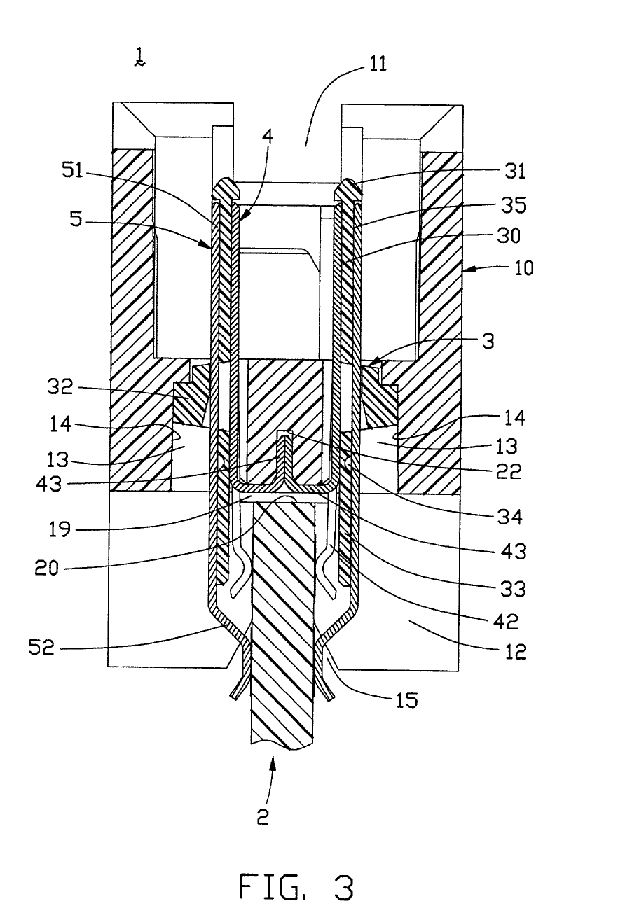

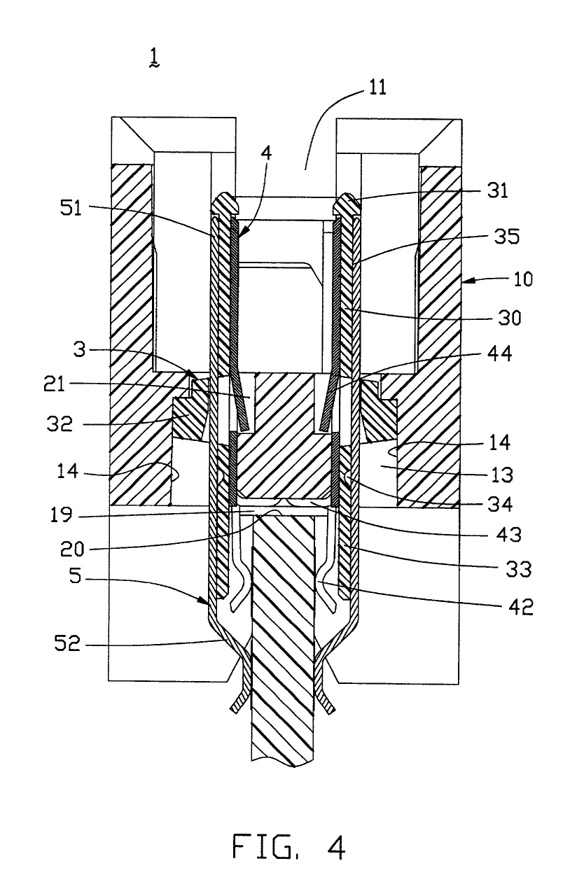

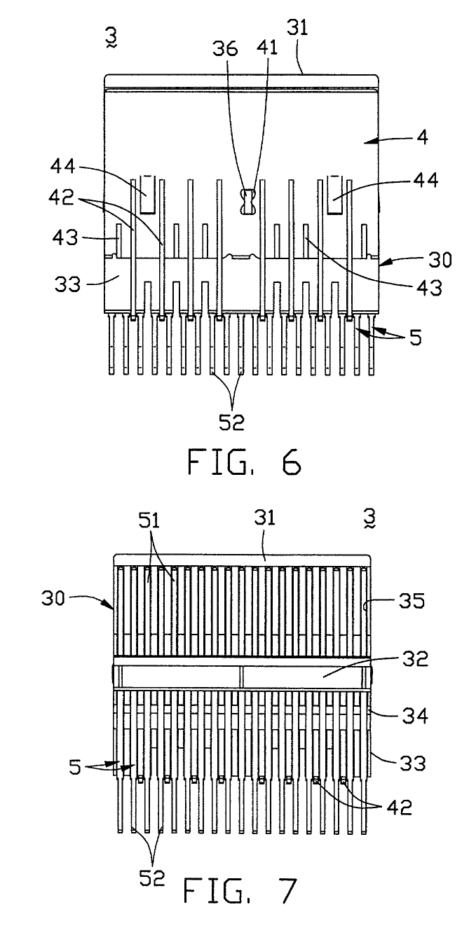

Referring to FIGS. 3 to 4 and 6 to 7, a molded support subassembly 3 with at least two kinds of conductors, signal and grounding, is inserted into and fixed in each receiving channel 13 from the corresponding opening on the opposing side face of the housing 10. The support subassembly 3 includes a plane-like base 30 having a lead-in edge portion 31 formed on one side of the base 30 and a separating portion 33 formed on the other side. A bar portion 32 transversely protruding from the middle part of one surface along the lengthwise direction of the base 30. And a flexible portion 34 with a thinned area disposed parallel to the bar portion 32 and abutting against the separating portion 33 is used as a hinge area to facilitate and ease the flexible or bending process for the final position of the separating portion 33. A plurality of parallel arranged passageways 35 are formed on the same surface of the base 30 where the bar portion 32 is seated and each of them passes through and underneath the bar portion 32. A protrusion 36 is formed on the other surface of the base 30 and is inversely protruded away from the bar portion 32 right at the back of the bar portion 32. Pin-like signal terminals 5, one kind of conductors, with the same number as the passageways 35 are inserted into the passageways 35 respectively along the surface of the base 30 from the separating portion 33 side to the lead-in edge portion 31 side. These terminals 5 can be held in the bar portion 32 and fixed in the corresponding passageways 35 by their own barbs formed on these terminals 5. The engaging end 51 of every terminal 5 stays in the end of its corresponding passageway 35 and is exposed to the mating groove 11 when the terminal 5 is inserted into the housing 10 accompanying with the support subassembly 3. And the tail end 52 of every terminal is then extending out of the receiving channel 13 of the housing 10 and aligning with each other between the mounting portions 12 formed near two ends of the housing 10 respectively. In addition, a plate-like grounding member 4 is formed abutting against the other surface of the support subassembly 3 where the protrusion 36 is located. A hole 41 with its projections directed inward is formed near the center of the grounding member 4 corresponding to the protrusion 36 of the base 30 and is used to fix the grounding member 4 onto the base 30 by clasping the protrusion 36 held inside the hole 41. A plurality of contacting legs 42 are formed with portions stamped out of the grounding member 4 and each has a distal end extending parallel to each other away from the grounding member 4 in a predetermined distance. Holding portions 43 formed in a hook shape on the edge side of the grounding member 4 neighboring the contacting legs 42 each extends vertically away from the surface of the base 30 and has it distal end parallel to the surface and pointing approximately to the reverse direction of the extending direction of the contacting legs 42. And two tabs 44 are formed on predetermined positions of the middle portion of the grounding member 4 and stamped out of the grounding member 4 to extend laterally in a predetermined length along the similar extending direction of the contacting legs 42.

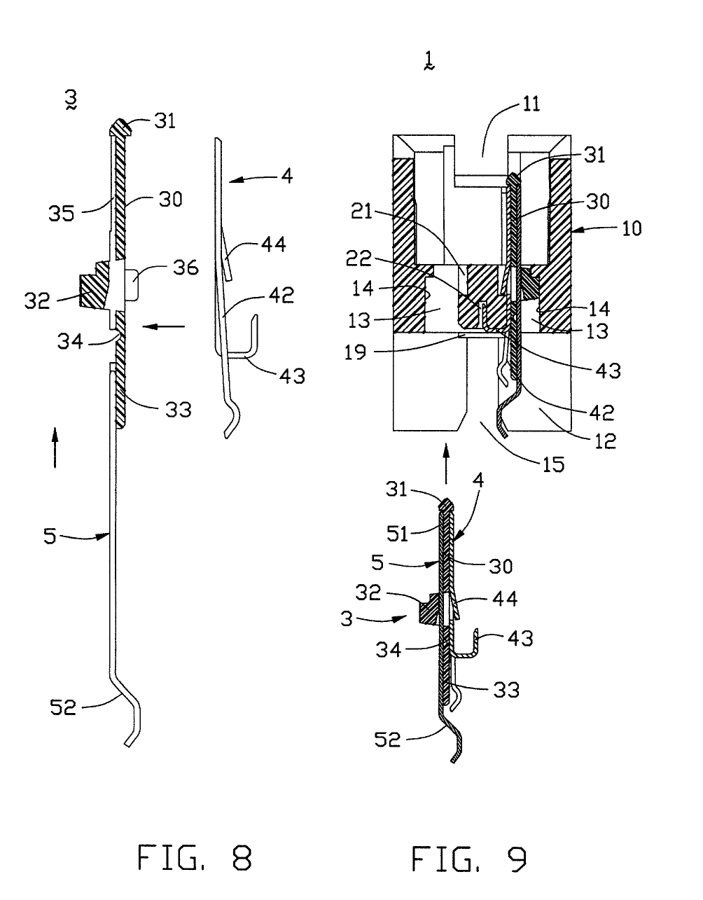

Referring to FIGS. 8 and 9, while assembling, signal terminals 5 are inserted into their corresponding passageways 35 respectively along the surface of the base 30 and each is held in the middle portion by the bar portion 32. And then the grounding member 4 is positioned on the other surface of the base 30 by latching the central hole 41 on the protrusion 36 of the base 30 to form a complete support subassembly 3. Every portion of the grounding member 4 is electrically insulated from the terminals with the base 30 including the suspended contacting leg 42 which is isolated from the neighboring tail ends of terminals by the separating portion 33 of the base 30. Every support subassembly 3 is then inserted into the housing 10 from the corresponding opening of the receiving channel 13. And two support subassembly 3 received in two adjacent receiving channels 13 of different rows are reversely arranged to have tail ends 52 of their terminals 5 and contacting legs 42 of their grounding member 4 facing toward each other respectively to form a space between them for holding the edge 20 of the printed circuit board 2 in position. Additionally, at the very beginning of insertion of each support subassembly 3, the bar portion 32 of the support subassembly 3 is engaged upon the sidewall 14 of the receiving channel 13 while the tabs 44 of the grounding member 4 are engaged with and slide along the surface of the central portion of the housing 10 opposite to the sidewall 14. Due to the sloped surface of the sidewall 14, the support subassembly 3 is pushed toward the opposite surface and tabs 44 are pressed inward, toward the base 30, until the bar portion 32 is stopped at the end of the sidewall 14 and tabs 44 reach the corresponding recesses 21 of the central portion of the housing 10 to latch therein. Simultaneously every holding portion 43 of the grounding member 4 will move close to the opposite side face of the housing 10 to hook and be partially inserted into the apertures 22 formed on the housing 10. The plate portion of the grounding member 4 and engaging ends 51 of terminals 5 are then inserted along with the support subassembly 3 into the mating groove 11 and exposed therein as parts of the mating interface. At the same time, contacting legs 42 of the grounding member 4 and tail ends 52 of terminals 5 all extend outside of the housing 10 and their free ends used for electrical engagement are arranged in two rows parallel to the housing 10 respectively. The separating portion 33 of the base 30 remains staying outside of the housing 10 to separate the contacting legs from the tail ends 52. It is understood these engagement free ends of terminals 5 and the grounding member 4 will be used to engage with two corresponding rows of contacting pads formed near the edge 20 of the printed circuit board 2. And the separating portion 33 is useful to electrically isolate the free contacting legs 42 and tail ends 52 from each other to protect them from unwanted touch, resulting in a short circuit during either the assembly process of the support subassembly 3 or the straddle mounting process of the printed circuit board 2.

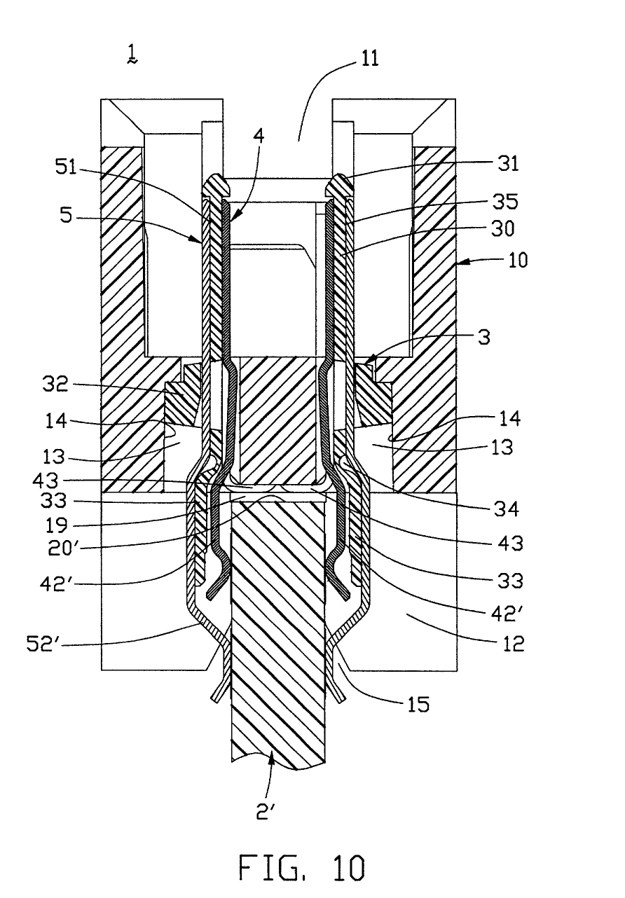

Referring to FIG. 10, a second embodiment for the electrical connector 1 in accordance with the present invention is shown to be straddle-mounted on an edge 20′ of another printed circuit board 2′ which has a larger board thickness. The shifting of engaging positions on this printed circuit board 2′ causes corresponding shape changes of the tail end 52′ of every terminal 5 and contacting legs 42′ of the grounding member 4 in order to be smoothly straddle mounted on the thicker printed circuit board 2′. The distance between two opposite tail ends 52′ or contacting legs 42′ is added in order to gain more space for the insertion of the printed circuit board 2′ while most mating portions of the support subassembly 3 in the mating groove 11 remain the same. Therefore, the separating portion 33 partitioning between one row of tail ends 52′ of terminals 5 and contacting legs 42′ of the grounding member 4 is moved farther away from the separating portion 33 of the other row to keep their positions between the tail ends 52′ and contacting legs 42′, and each separating portion 33 is offset from the base 30 by reshaping the thinned hinge area of the flexible portion 34 connected thereto. Besides, the mold making the whole base 30 is not necessary to be replaced and is easy to be adjusted to make bases 30 with varied offset separating portions 33 because the curved thinned area of the flexible portion 34 permits remarkable shape variation.

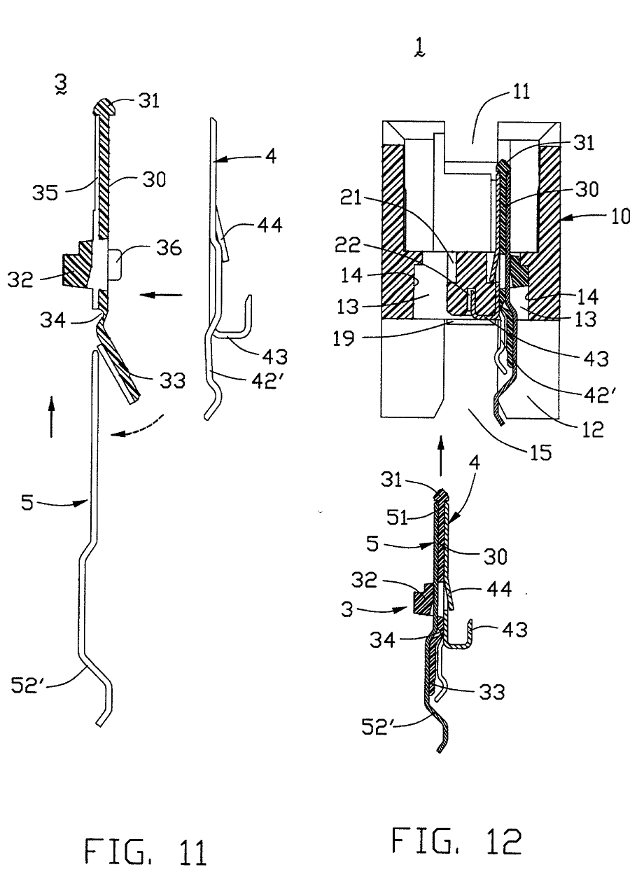

Referring to FIGS. 11 and 12, in this embodiment, the assembly process of the support subassembly 3 is changed because the offset separating portion 33 blocks the insertion entrance of every passageway 35 for its corresponding signal terminals 5. However, the flexible portion 34 is bent to move the offset separating portion 33 away from the insertion entrance before signal terminals 5 are inserted into their corresponding passageways 35 respectively. And then the separating portion 33 is moved back to its original and desired position before the grounding member 4 is positioned on the other surface of the base 30 to form a complete support subassembly 3. The separating portion 33 can still stay between tail ends 52′ of terminals 5 and contacting legs 42′ of the grounding member 4 in order to function as an isolator therebetween. Every support subassembly 3 is then inserted into the housing 10 from the corresponding opening of the receiving channel 13 to finish the assembling processes of the connector 1.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector straddle mounted on a printed circuit board comprising:
a housing having a mating groove to receive portions of a mating connector;
a support subassembly bearing with a plurality of conductors being inserted into the housing and extending into the mating groove to expose a mating portion of each conductor in the mating groove while a tail portion of each conductor is electrically engaged with the printed circuit board; wherein
a flexible portion is formed on the support subassembly and positioned between the mating portion and tail portion of every conductor to define the support subassembly as two portions, said flexible portion is the basis of moving one portion of the support subassembly relative to the other portion for the need of conductor-assembling and/or board-mounting.

2. The electrical connector as recited in claim 1, wherein said flexible portion is a hinged area with a thinned portion formed on a plastic base of the support subassembly.

3. The electrical connector as recited in claim 1, wherein said moving portion of the support subassembly is a separating portion formed as an electrically insulated partition positioned between the tail portions of two kinds of conductors.

4. The electrical connector as recited in claim 3, wherein the other portion of the support subassembly is a plastic plane base bearing with a plurality of parallel arranged passageways on one surface of the base to receive one kind of conductors.

5. The electrical connector as recited in claim 4, wherein another kind of conductors is placed on the other surface of the base and the tail portions of the conductor are extending along at one side of the separating portion.

6. The electrical connector as recited in claim 4, wherein the base further includes a bar portion transversely protruding from one of its surface used to be engaged upon a slant inner sidewall of the housing.

7. The electrical connector as recited in claim 1, wherein the conductors include pin-like signal terminals each having an engaging end functioning as the mating portion in the mating groove for mating and a tail end functioning as the tail portion to be electrically engaged with the printed circuit board.

8. The electrical connector as recited in claim 7, wherein the conductors further include a plane grounding member having its plane portion functioning as the mating portion in the mating groove for mating and a plurality of contacting legs which function as the tail portion to be electrically engaged with the printed circuit board.

9. The electrical connector as recited in claim 8, wherein said grounding member further includes several holding portions formed in a hook shape on one of its edge sides neighboring the contacting legs.

10. The electrical connector as recited in claim 9, wherein the housing further includes apertures for the insertion of holding portions of the grounding member to stop the insertion of the support subassembly into the housing.

11. The electrical connector as recited in claim 8, wherein said grounding member further includes two tabs formed on the middle portion of the grounding member and stamped out of the grounding member to extend laterally for a predetermined length.

12. The electrical connector as recited in claim 11, wherein the housing further includes recesses formed to receive the tabs for securing the support subassembly in the housing.

13. The electrical connector as recited in claim 1, wherein the housing further includes an anchoring member received at its two distal ends used to be yieldably engaged with the printed circuit board.

14. An electrical connector straddle mounted on a printed circuit board comprising:
a housing having a mating side face of the housing used to mate with a mating connector and a mounting side face opposing to the mating side face abutting against one edge of the printed circuit board;
a support subassembly comprising of at least two kinds of conductors carrying two different signals and having an electrically insulated base to install the conductors, said support subassembly being received in the housing to have one end of each conductor being exposed to the mating side face to electrically connect to the mating connector and the other end of each conductor extending from the mounting side face in a suspended status to be electrically engaged with the printed circuit board; wherein
said base has a separating portion extending from the mounting side face of the housing for a predetermined length and staying between said suspended ends of said two kinds of conductors to avoid said two kinds of conductors from undesired circuit shorting.

15. The electrical connector as recited in claim 14, wherein one kind of said conductors is signal terminals being insertably received in passageways formed on one surface of said base.

16. The electrical connector as recited in claim 14, wherein one kind of said conductors is a plane-like grounding member installed and abutting against one surface of said base.

17. The electrical connector as recited in claim 14, wherein an flexible portion formed on said base adjacent to the separating portion to facilitate moving of the separating portion for the need of conductors assembling or board-mounting.

18. An electrical connector assembly comprising:
an insulative housing defining an elongated mating groove and a receiving channel communicating with each other; and
a support subassembly including a plane-like base with a plurality of juxtaposed signal terminals on one surface thereof and a grounding member on the other surface thereof, said support subassembly extending through said receiving channel and into the mating groove; wherein
said grounding member includes retention means to latchably engage the housing for retaining said subassembly to said housing.

19. An electrical connector assembly comprising:
an insulative housing defining an elongated mating groove and a receiving channel communicating with each other; and
a support subassembly including a plane-like base with a plurality of juxtaposed signal terminals on one surface thereof and a grounding member on the other surface thereof, said support subassembly extending through said receiving channel and into the mating groove;
said signal terminals including tails, said grounding member including contacting legs, both of said tails and said legs extending rearwardly around a rear portion of the housing, said base including a separating portion isolating said tails and said legs from each other; wherein
the separating portion with the tails and the contacting legs thereon is pivotal relative to the housing for compliance with different thickness printed circuit boards engaged therewith.
